(19) United States
(12) Patent Application Publication
(10) Pub. No.: US 2007/0287567 A1
(43) Pub. Date: Dec. 13, 2007

(54) TRANSMISSION

(75) Inventors: Soichi SUGINO, Saitama (JP); Tsukasa TAKAHASHI, Saitama (JP); Yasuhiro SAWA, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Minato-ku, Tokyo (JP)

(21) Appl. No.: 11/758,811

(22) Filed: Jun. 6, 2007

(30) Foreign Application Priority Data
Jun. 7, 2006 (JP) 2006-158088

(51) Int. Cl. F16H 37/02

(52) U.S. Cl. 475/214

(57) ABSTRACT

The present invention includes an input side transmission unit that transforms the rotation of the input shaft that rotates by receiving input rotation into N steps, and transmits the transformed rotation to the counter shaft; and an output side transmission unit that includes a first planet gear train and a second planet gear train, and that transforms the rotation of the counter shaft and outputs the transformed rotation to the output shaft. Of the first through fourth rotating elements constituting the output side transmission unit, the first and second sun gears are connected so that they can be freely engaged with or disengaged from the input shaft via the first clutch; the first carrier is connected to the output shaft; the second carrier and the first ring gear are connected so that they can be freely engaged with or disengaged from the input shaft via the second clutch and can be held fixed by the second brake; and the second ring gear can be held fixed by the first brake, and is connected to the upstream side output member.

### FIELD OF THE INVENTION

The present invention relates to a transmission which is constituted to have a planet gear train, and which transforms the speed of rotation of the input shaft and outputs it to the output shaft.

### BACKGROUND OF THE INVENTION

There is a trend towards increasing the number of gear speeds in transmissions used in vehicles, as a result of requirements to improve the fuel consumption and acceleration performance (for example, see Japanese Patent Application Laid-open No. 2000-266138). In this type of transmission, the number of gear speeds is increased by providing a plurality of planet gear trains.

However, if the number of gear speeds is increased, the number of meshing elements is increased accordingly. Therefore, the structure of the transmission becomes more complex. In particular, there is the problem that as the number of gear speeds increases the weight of the transmission increases, and the manufacturing cost also increases.

### SUMMARY OF THE INVENTION

It is an object of the present invention to provide a transmission for which the design can be easily changed when the structure of the transmission is changed, and for which the manufacturing cost can be minimized.

The transmission according to the present invention includes an upstream side transmission mechanism (for example, the input side transmission unit UI in the embodiments) that transforms the rotation of an upstream side input member (for example, the input shaft 1 in the embodiments) that is rotated by receiving input rotation, into N steps, and transmits the transformed rotation to an upstream side output member; and a compound planet gear transmission mechanism (for example, the output side transmission unit UO in the embodiments) having two or more planet gear trains (for example, the first planet gear train 40 and the second planet gear train 50 in the embodiments), that transforms the rotation of the upstream side output member and outputs the transformed rotation to an output shaft (for example, the output shaft 4 in the embodiments) of the transmission. The compound planet gear transmission mechanism has first through fourth rotating elements. The first rotating element can be freely engaged with or disengaged from the upstream side input member via first clutch means (for example, the first clutch K1 in the embodiments). The second rotating element is connected to the output shaft of the transmission. The third rotating element can be freely engaged with or disengaged from the upstream side input member via second clutch means (for example, the second clutch K2 in the embodiments), and can be held fixed by second brake means (for example, the second brake B2 in the embodiments). The fourth rotating element can be held fixed by first brake means (for example, the first brake B1 in the embodiments), and is connected to the upstream side output member.

Also, in the transmission as described above, preferably the compound planet gear transmission mechanism comprises single pinion type first and second planet gear trains having the same gear ratio. The first rotating element comprises a first sun gear and a second sun gear forming the first and second planet gear trains respectively, connected together. The second rotating element comprises a first carrier forming the first planet gear train. The third rotating element comprises a second carrier forming the second planet gear train and a first ring gear forming the first planet gear train, connected together. The fourth rotating element comprises a second ring gear forming the second planet gear train.

Furthermore, in the above transmission, preferably the third rotating element further comprises a one way brake that prevents rotation in the direction opposite to the input rotation, but allows rotation in the same direction.

Also, in the above transmission, preferably the upstream side transmission mechanism comprises a parallel shaft transmission mechanism.

Also, in the above transmission, the upstream side transmission mechanism may be a planet gear type transmission mechanism.

According to the transmission of the present invention, the transmission includes two units: an upstream side transmission mechanism provided on the upstream side, and a compound planet gear transmission mechanism provided on the downstream side. By modifying the upstream side transmission mechanism without modifying the compound planet gear transmission mechanism on the downstream side, and combining the modified structure with the compound planet gear transmission mechanism, it is possible to increase (or decrease) the number of gear speeds in the transmission. In this way, by making the components of the compound planet gear transmission mechanism in the downstream side of the transmission common, components are made compatible, design changes are easy when changing the structure of the transmission (increasing or decreasing the number of gear speeds), and in particular the manufacturing cost of the transmission can be reduced when increasing the number of gear speeds.

Also, the compound planet gear transmission mechanism provided on the downstream side is formed by the combination of the first and second planet gear trains, which are single pinion type gear trains with comparatively simple structures. Therefore, it is possible to prevent an increase in size of the transmission mechanism on the downstream side, increase in complexity of the transmission as a whole is prevented, and the manufacturing cost can be reduced.

Furthermore, the third rotating element has a one way brake that prevents rotation in the direction opposite to the input rotation, but allows rotation in the same direction. Therefore when a torque acts to rotate the output shaft in the opposite direction to the input shaft, the first ring gear that forms part of the third rotating element rotates in the same direction as the first sun gear. In this case, rotation of the first ring gear is not restricted by the one way brake, the first ring gear freely rotates, so power is not transmitted from the input shaft to the output shaft. In this way, by preventing power transmission in the opposite direction to the rotation of the input shaft by the one way brake, it is possible to restrain the reduction in rate of rotation of the output shaft when shifting down. Therefore, it is possible to avoid applying the engine brake when in the first gear speed. Also, using the one way brake, the third rotation element prevents rotation in the opposite direction to the input rotation, and allows rotation in the same direction as the input direction. Therefore it is possible to implement change of gear speeds (in the embodiments, change of gear between the first and second gear speeds) in the embodiments by holding fixed or releasing by the second brake means (in the embodiments, it is not necessary to control the fixing and releasing by the first brake). Therefore, the controllability can be improved.

Also, by forming the upstream side transmission mechanism with a parallel shaft transmission mechanism, and combining it with the planet gear trains that form the compound type planet gear transmission mechanism on the downstream side, it is possible to increase the number of gear speeds in the transmission with fewer components than the case where the upstream side transmission mechanism is formed with planet gear trains. Therefore it is possible to make the whole transmission lighter (which also results in a reduction in the manufacturing cost of the transmission). Also, by making the upstream side transmission mechanism a parallel shaft transmission mechanism, it is possible to simplify the overall structure of the transmission. By increasing or reducing the number of gear trains in the parallel shaft transmission mechanism (by changing the number of gear trains in the axial direction of the input shaft), it is possible to freely set the number of gear speeds in the transmission.

In the case where the upstream side transmission mechanism is constituted by a planet gear transmission mechanism, if single pinion type first and second planet gear trains are combined in the same way as in the downstream side planet gear transmission mechanism, it is possible to prevent an increase in the size of the upstream side transmission mechanism compared with the case where a double pinion type planet gear transmission mechanism is used. In addition, it is possible to minimize the torque transmitted to the downstream side transmission mechanism. Therefore, the tangential loads on the gear teeth of the downstream side transmission mechanism can be reduced, and the friction losses can be reduced. If the friction losses can be reduced, the controllability of the transmission is increased.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 is a schematic diagram of a vehicle having the automatic transmission according to the present invention;

FIG. 2 is a skeleton diagram showing the automatic transmission according to the first embodiment;

FIG. 3 is a velocity diagram showing the relationship between the speed of each element of the planet gear trains in the automatic transmission according to the first embodiment;

FIG. 4 is a skeleton diagram showing the automatic transmission according to the second embodiment;

FIG. 5 is a velocity diagram showing the relationship between the speed of each element of the planet gear trains in the automatic transmission according to the second embodiment;

FIG. 6 is a skeleton diagram showing the automatic transmission according to the third embodiment;

FIG. 7 is a velocity line diagram showing the relationship between the speed of each element of the planet gear trains in the automatic transmission according to the third embodiment;

FIG. 8 is a skeleton diagram showing the automatic transmission according to the fourth embodiment;

FIG. 9A is a table showing the relationship between the gear trains and ratios in the automatic transmission according to the first embodiment, FIG. 9B is a table showing the relationship between the gear speeds and ratios in the automatic transmission according to the first embodiment;

FIG. 10A is a table showing the relationship between the gear trains and ratios in the automatic transmission according to the fourth embodiment, FIG. 10B is a table showing the relationship between the gear speeds and ratios in the automatic transmission according to the fourth embodiment;

FIG. 11 is a table showing the relationship between the ratio range and the speed reduction ratio of each gear train in the automatic transmission, in the first and fourth embodiments;

FIG. 12 is a diagram comparing the velocity diagrams for the first and fourth embodiments, FIG. 12(a) is the velocity diagram in the first embodiment, and FIG. 12(b) is the velocity diagram in the fourth embodiment;

FIG. 13 is a skeleton diagram showing the automatic transmission according to the fifth embodiment;

FIG. 14 is a skeleton diagram showing an embodiment that is different from the first through fifth embodiments of the automatic transmission; and

FIG. 15 is a skeleton diagram showing an embodiment that is different from the first through fifth embodiments of the automatic transmission.

### DESCRIPTION OF THE PREFERRED EMBODIMENTS

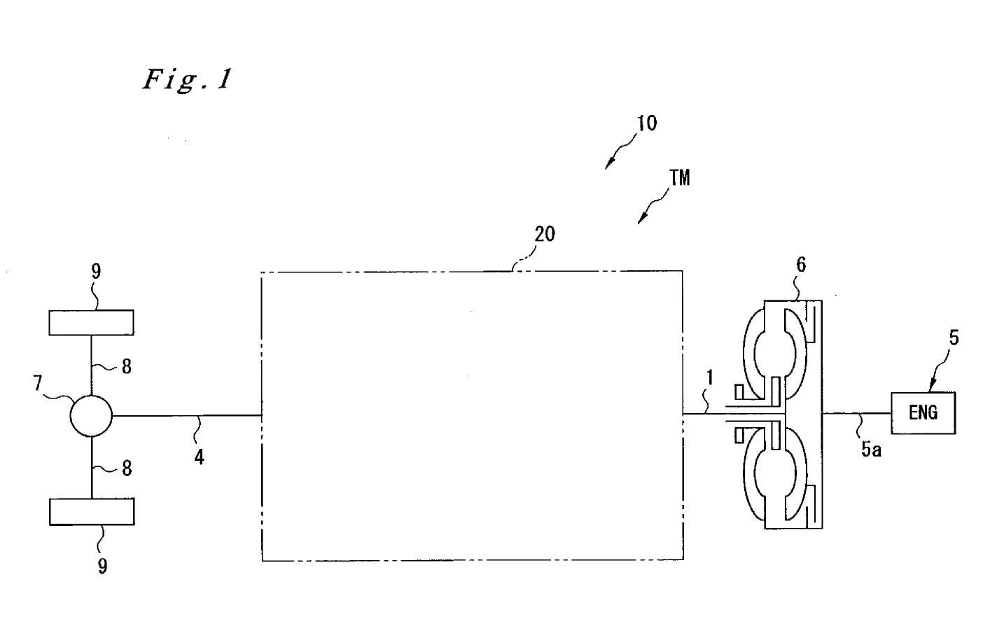

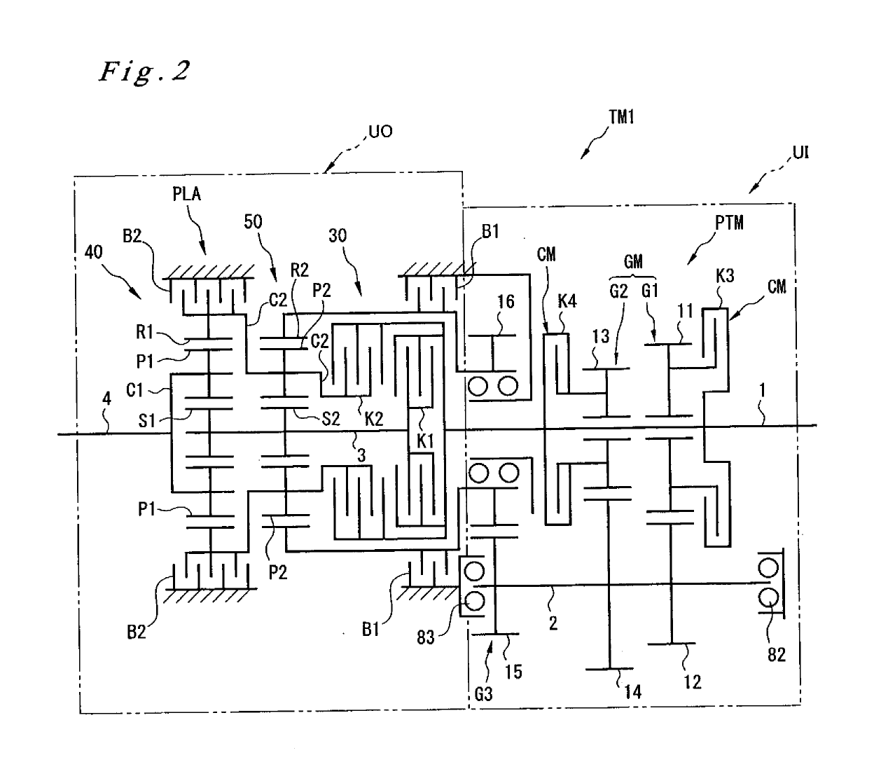

The following is an explanation of the preferred embodiments of the present invention with reference to the drawings. In FIGS. 1 and 2 and elsewhere, the right side (engine side) is referred to as the input side or the upstream side, and the left side (drive wheel side) is referred to as the output side or the downstream side.

FIG. 1 shows a power transmission device 10 having an automatic transmission TM according to the present invention. The power transmission device 10 is mounted in for example an FR type vehicle. The power transmission device 10 includes an engine 5 disposed to the front of the vehicle, an automatic transmission TM an input shaft 1 of which is connected via a torque converter 6 to an output shaft 6a of the engine 5, and a differential mechanism 7 connected to an output shaft 4 of the automatic transmission TM. The rotation drive power of the input shaft 1 that rotates in a specific direction at a specific rotation speed Ne in accordance with the drive power of the engine 5 is transformed in the automatic transmission TM, divided to left and right differential shafts 8, 8 by the differential mechanism 7, and transmitted to the left and right drive wheels (rear wheels) 9, 9. In FR type vehicles, frequently the power transmission 10 is structured so that the input shaft connection portion and the output shaft connection portion of the transmission TM are laid out in positions on the same axis extending in the front to rear direction of the vehicle as shown in FIG. 1. The automatic transmission TM is housed in the internal space of a casing 20 formed by assembling a plurality of case members.

The automatic transmission TM includes a gear change control device that is not shown in the drawings, structured to carry out control of gear changes. The gear change control device is structured to carry out control of the operation of each engaging element that includes a plurality of clutches or brakes provided within the automatic transmission TM, in accordance with the vehicle conditions. A plurality of gear speeds is set within the automatic transmission TM in accordance with the operating conditions (whether meshed or not meshed) of these engaging elements. The automatic transmission TM transforms the rotation speed of the input shaft 1 in accordance with the gear speed set by the gear change control device, and rotates the output shaft 4.

### Embodiment 1

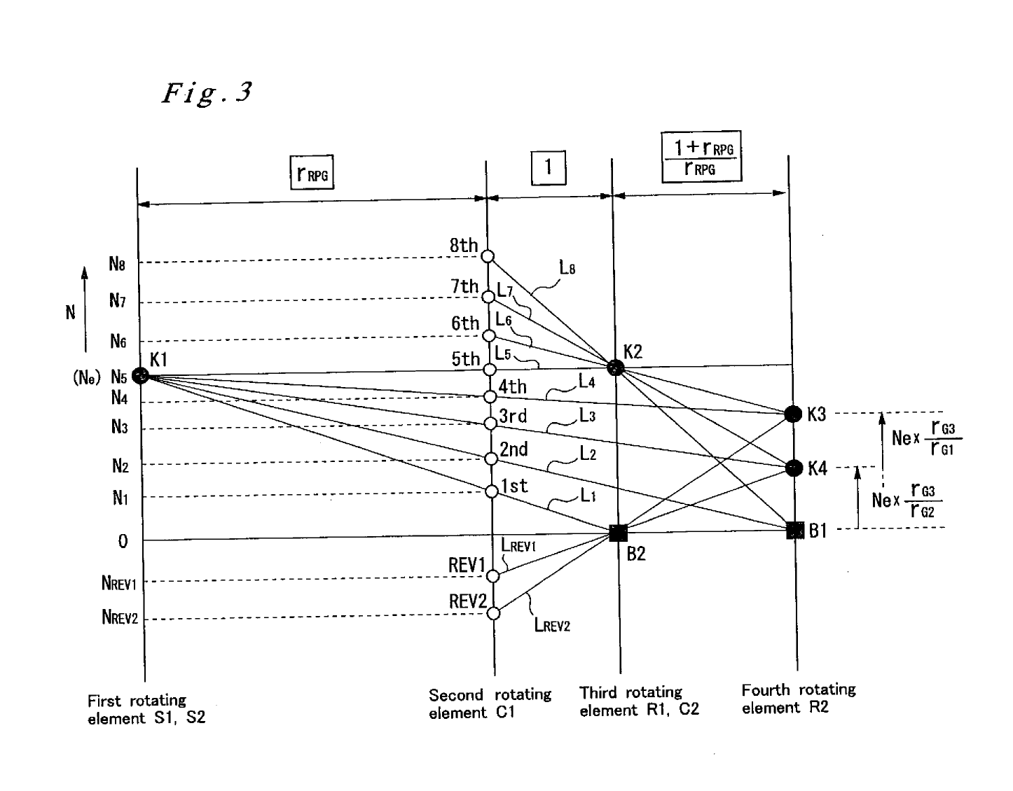

The following is an explanation of an automatic transmission TM1 according to the first embodiment, with reference to FIGS. 2 and 3.

As shown in FIG. 2, the automatic transmission TM1 according to the first embodiment includes a parallel shaft type transmission PTM, a compound planet gear train PLA, and planet gear engaging elements 30.

The input shaft 1 is provided extending from the upstream side to the downstream side within the casing 20, and is rotatably supported on the upstream side by a bearing that is not shown on the drawings. A counter shaft 2 is provided within the casing 20 extending parallel to the input shaft 1. The counter shaft 2 is rotatably supported on the upstream side by a bearing 82, and on the downstream side by a bearing 83. The counter shaft 2 is disposed below the input shaft 1 within the internal space of the casing 20. A center shaft 3 is provided to the downstream side of the input shaft 1 and extends on the same axis as the input shaft 1.

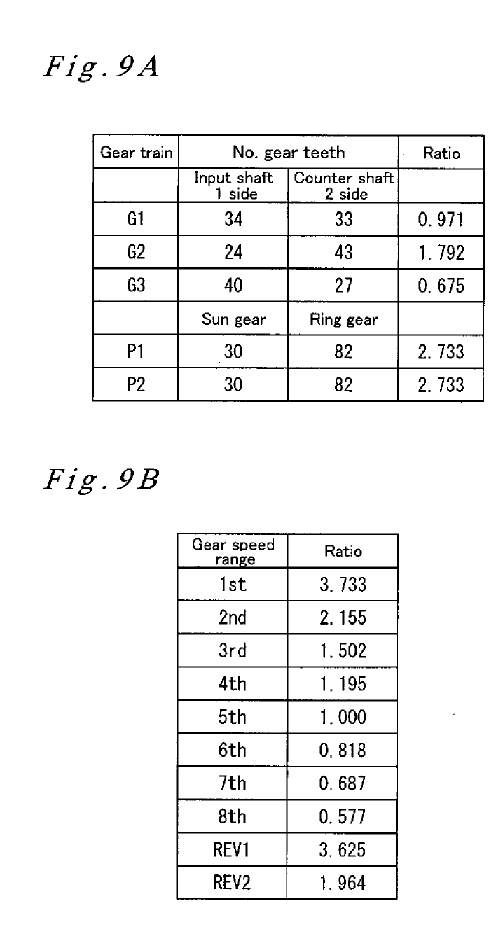

An input side gear train GM that forms part of the parallel shaft type transmission PTM includes a first gear train G1, a second gear train G2, and a third gear train G3. The gear ratios of the gear trains G1 through G3, r_{G1}, r_{G2}, r_{G3} are obtained by dividing the number of gear teeth on the counter shaft 2 side by the number of gear teeth on the input shaft 1 side (see FIG. 9A). Here, the gear ratios r_{G1}, r_{G3} of the first and third gear trains G1, GS are set smaller than one, and the gear ratio r_{G2} of the second gear train G2 is set larger than one.

The first input gear train G1 includes a first drive gear 11 capable of rotating relative to the input gear 1, and a first driven gear 12 that meshes with the first drive gear 11 and is connected to the counter shaft 2 and is capable of rotating integrally with the counter shaft 2. The first drive gear 11 can be freely engaged with and disengaged from the input shaft 1 via a third clutch K3 provided on the input shaft 1 and that rotates integrally with the input shaft 1. When the third clutch K3 is engaged, the counter shaft 2 rotates faster than the input shaft 1 at the speed (Ne×1/r_{G1}) in accordance with the gear ratio r_{G1} of the first gear train G1, and in the opposite direction to the input shaft 1.

The second gear train G2 includes a second drive gear 13 capable of rotating relative to the input shaft 1, and a second driven gear 14 that meshes with the second drive gear 13 and is connected to the counter shaft 2 and is capable of rotating integrally with the counter shaft 2. The second drive gear 13 can be freely engaged with and disengaged from the input shaft 1 via a fourth clutch K4 provided on the input shaft 1 and that rotates integrally with the input shaft 1. When the fourth clutch K4 is engaged, the counter shaft 2 rotates slower than the input shaft 1 at the speed (Ne×1/r_{G2}) in accordance with the gear ratio r_{G2} of the second gear train G2, and in the opposite direction to the input shaft 1.

The third gear train G3 includes a third drive gear 15 provided on the counter shaft 2 and capable of rotating integrally with the counter shaft 2, and a third driven gear 16 that meshes with the third drive gear 15 and is capable of rotating about the input shaft 1 relative to the input shaft 1. The third driven gear 16 rotates slower than the counter shaft 2 at the speed (Nc×r_{G3}) in accordance with the gear ratio r_{G3} of the third gear train G3, and in the opposite direction to the counter shaft 2, in other words, in the same direction as the input shaft 1. The third driven gear 16 is connected to a second ring gear R2 that is described later.

The third and fourth clutches K3, K4 form the input side gear engaging elements CM. The third and fourth clutches K3, K4 are disposed on the input shaft 1 in a line in the long axis direction of the input shaft 1.

The planet gear engaging elements 30 include a first clutch K1 disposed on the input shaft 1 and the center shaft 3, a second clutch K2, a first brake B1, and a second brake B2. The output side of the input shaft 1 and the input side of the center shaft 3 can be freely engaged or disengaged via the first clutch K1. When the first clutch K1 is engaged, the rotation of the input shaft 1 is transmitted unchanged to the center shaft 3, and the center shaft 3 rotates integrally with the input shaft 1. Also, the output side of the input shaft 1 can be freely engaged with and disengaged from a second carrier C2 that forms part of the compound planet gear train PLA that is described later, via the second clutch K2.

The compound planet gear train PLA includes a single pinion type first planet gear train 40 and a second planet gear train 50 structured as described below. The compound planet gear train PLA includes four rotating elements: a first rotating element, a second rotating element, a third rotating element, and a fourth rotating element.

The first planet gear train 40 includes a first sun gear S1 capable of freely rotating about a rotation axis positioned on the center shaft 3 as center; a first pinion gear P1 that meshes with the first sun gear S1 and that rotates while revolving around the first sun gear S1; a first carrier C1 that rotatably supports the first pinion gear P1 via a needle bearing, and that is fixed to the output shaft 4 and revolves about the output shaft 4 as the center of rotation at the same speed as the first pinion gear P1; and a first ring gear R1 having internal teeth that mesh with the first pinion gear P1 and whose axis is the same as the rotation axis of the first sun gear S1 and that is capable of rotating about the rotation axis. When the first clutch K1 is engaged, the rotation of the input gear 1 is directly transmitted to the first sun gear S1 via the center shaft 3. Also, the first planet gear train 40 is set to a predetermined ratio (gear ratio) r_{RPG} obtained by dividing the number of teeth on the first ring gear R1 by the number of teeth in the first sun gear S1 (see FIG. 9A).

The second planet gear train 50 includes a second sun gear S2 capable of freely rotating about a rotation axis positioned on the center shaft 3 as center; a second pinion gear P2 that meshes with the second sun gear S2 and that rotates while revolving around the second sun gear S2; the second carrier C2 that rotatably supports the second pinion gear P2 via a needle bearing, and that revolves about the center shaft 3 as the center of rotation at the same speed as the second pinion gear P2; and the second ring gear R2 having internal teeth that mesh with the second pinion gear P2 and whose axis is the same as the rotation axis of the second sun gear S2 and that is capable of rotating about the rotation axis. Also, the second planet gear train 50 is set to a predetermined ratio (gear ratio) r_{RPG} obtained by dividing the number of teeth on the second ring gear R2 by the number of teeth in the second sun gear S2 (see FIG. 9A). However, the number of teeth in the second ring gear R2 is the same as the number of teeth in the first ring gear R1, and the number of teeth in the second sun gear S2 is the same as the number of teeth in the first sun gear S1. Therefore the value of the ratios for the first planet gear train 40 and the second planet gear train 50 are the same. The first ring gear R1 is provided integral with the second carrier C2, and rotates integrally with the second carrier C2. In addition the first ring gear R1 can be held fixed together with the second carrier C2 by the second brake B2. Also, the second carrier C2 is connected so that it can be freely engaged with and disengaged from the input shaft 1 via the second clutch K2. Further, the second ring gear R2 is connected so as to be capable of rotating integrally with the third driven gear 16. In addition the second ring gear R2 can be held fixed together with the third driven gear 16 by the first brake B1.

The axis of rotation of the first carrier C1 is connected to the output shaft 4 which extends on the downstream side. In this way, in the automatic transmission TM1, the center shaft 3 is provided on the same axis as the input shaft 1, and the axes of rotation of the first and second planet gear trains 40, 50 are the same as the axis of rotation of the center shaft 3. The output shaft 4 is connected on the same axis as the rotation axis of one of the elements (in other words, the rotation axis of the first sun gear S1) of the first planet gear train 40. Therefore the input shaft 1 and the output shaft 4 are disposed on the same axis.

The compound planet gear train PLA is structured as described above. Within the compound planet gear train PLA, the first rotating element includes the first sun gear S1 connected to the second sun gear S2; the second rotating element includes the first carrier C1 and the first pinion gear P1; the third rotating element includes the second pinion gear P2, the second carrier C2, and the first ring gear R1; and the fourth rotating element includes the second ring gear R2.

Within this structure, the input side (upstream side) of the automatic transmission TM1 forms the input side transmission unit UI that includes the parallel shaft type transmission PTM and the input side gear engaging elements CM. In the input side transmission unit UI the rotation of the input shaft 1 is transformed and output to the counter shaft 2. The output side (downstream side) of the automatic transmission TM1 forms the output side transmission unit UO that includes the compound planet gear train PLA, the planet gear engaging elements 30, the first brake B1, and the second brake B2, that transforms the rotation of the counter shaft 2, and outputs the rotation to the output shaft 4.

By carrying out control by the gear change control device to selectively engage the frictional engaging elements K1 through K4, B1, B2 as shown in Table 1, the automatic transmission TM1 structured as described above can set eight forward gear speeds (1^{st} through 8^{th}) and two reverse speeds (REV1, REV2). The symbol in Table 1 indicates that the frictional engaging element is in the engaged state. At each gear speed, two frictional engaging elements are set to be engaged. Also, when changing gear speeds between two adjacent gear speeds, one of the two frictional engaging elements remains engaged, and the other is disengaged and another one frictional engaging element is engaged. Therefore it is possible to smoothly change gear speeds.

TABLE 1

| | K1 | K2 | K3 | K4 | B1 | B2 |
|---|---|---|---|---|---|---|
| R2 | | | | | | |
| R1 | | | | | | |
| 1 | | | | | | |
| 2 | | | | | | |
| 3 | | | | | | |
| 4 | | | | | | |
| 5 | | | | | | |
| 6 | | | | | | |
| 7 | | | | | | |
| 8 | | | | | | |

FIG. 3 shows the velocity diagram of the compound planet gear train PLA. The four vertical axes indicate the rotation speed N of, from the left, the first and second sun gears S1, S2 serving the first rotational element, the first carrier C1 serving the second rotational element, the first ring gear R1 and the second carrier C2 serving the third rotational element, and the second ring gear R2 serving the fourth rotational element, these elements constituting the compound planet gear train PLA. The length of the vertical lines corresponds to the rotational speed N. Also, the ratios of the spacing between the first rotational element and the second rotational element, and the spacing between the second rotational element and the third rotational element, and the spacing between the third rotational element and the fourth rotational element are set to r_{RPG}: 1:(1+r_{RPF})/r_{RPG}. The symbol on the vertical axes for the first rotational element, the third rotational element, and the fourth rotational element indicates engagement of a clutch. The ▪ symbol indicates engagement of a brake. Also, the rotation speed N is positive in the direction of rotation of the input shaft 1. When the output shaft 4 rotates in the positive direction, in other words, when the first carrier C1 revolves in the positive direction, the vehicle moves forward. The following is an explanation of each gear speed with reference to FIG. 3.

The first gear speed is set when the first clutch K1 and the second brake B2 are both engaged. At this time, by engaging the first clutch K1 the center shaft 3 rotates integrally with the input shaft 1. Therefore, the first sun gear S1 and the second sun gear S2 rotate at the rotation speed Ne of the input shaft 1 and in the same direction as the input shaft 1 (the positive direction). As a result of engaging the second brake B2, the first ring gear R1 is held fixed and does not rotate. Therefore, the first carrier C1 rotates in the positive direction at the rotation speed N₁ indicated by the point of intersection of the straight line L₁ joining these two points (K1 and B2) and the vertical axis that represents the rotation speed of the first carrier C1. In other words, the output shaft 4 rotates at the speed N₁ in the positive direction.

The second gear speed is set when the second brake B2 is disengaged from the state of the first gear speed, and the first brake B1 is engaged. At this time the first sun gear S1 and the second sun gear S2 rotate at the same speed as for the first gear speed, Ne, in the positive direction. The second ring gear R2 is held fixed and does not rotate, due to engaging the first brake B1. Therefore, the first ring gear R1 and the second carrier C2 rotate in the positive direction at a speed indicated by the point of intersection of the straight line L₂ joining these two points (K1 and B1) and the vertical axis representing the rotation speed of the first ring gear R1 and the second carrier C2. The first carrier C1 rotates in the positive direction at the rotation speed N2 indicated by the point of intersection of the straight line L₂ and the vertical axis that represents the rotation speed of the first carrier C1. In other words, the output shaft 4 rotates at the speed N₂ in the positive direction.

The third gear speed is set when the first brake B1 is disengaged from the state of the second gear speed, and the fourth clutch K4 is engaged. At this time, the first sun gear S1 and the second sun gear S2 rotate at the same speed as for the first gear speed, Ne, in the positive direction. As a result of engaging the fourth clutch K4, the counter shaft 2 rotates in the opposite direction to the input shaft 1 at the rotation speed (Ne×1/r_{G2}) which is reduced relative to the input shaft 1 in accordance with the gear ratio r_{G2} of the second gear train G2. Therefore, the second ring gear R2 rotates in the positive direction of the input shaft 1 at the rotation speed (Ne×1/r_{G2}×r_{G3}) which is transformed relative to the third drive gear 15 in accordance with the gear ratio r_{G3} of the third gear train G3. Therefore, the first ring gear R1 and the second carrier C2 rotate in the positive direction at a speed indicated by the point of intersection of the straight line L₃ and the vertical axis representing the rotation speed of the first ring gear R1 and the second carrier C2. The first carrier C1 rotates in the positive direction at the rotation speed N₃ indicated by the point of intersection of the straight line L₃ and the vertical axis that represents the rotation speed of the first carrier C1. In other words, the output shaft 4 rotates at the speed N₃ in the positive direction.

The fourth gear speed is set when the fourth clutch K4 is disengaged from the state of the third gear speed, and the third clutch K3 is engaged. At this time, the first sun gear S1 and the second sun gear S2 rotate at the same speed as for the first gear speed, Ne, in the positive direction. As a result of engaging the third clutch K3, the counter shaft 2 rotates in the opposite direction to the input shaft 1 at the rotation speed (Ne×1/r_{G1}) which is increased relative to the input shaft 1 in accordance with the gear ratio r_{G1} of the first gear train G1. Therefore, the second ring gear R2 rotates in the positive direction of the input shaft 1 at the rotation speed (Ne×1/r_{G1}×r_{G3}) which is transformed relative to the third drive gear 15 in accordance with the gear ratio r_{G3} of the third gear train G3. Therefore, the first ring gear R1 and the second carrier C2 rotate in the positive direction at a speed indicated by the point of intersection of the straight line L₄ and the vertical axis representing the rotation speed of the first ring gear R1 and the second carrier C2. The first carrier C1 rotates in the positive direction at the rotation speed N₄ indicated by the point of intersection of the straight line L₄ and the vertical axis that represents the rotation speed of the first carrier C1. In other words, the output shaft 4 rotates at the speed N4 in the positive direction.

The fifth gear speed is set when the third clutch K3 is disengaged from the state of the fourth gear speed, and the second clutch K2 is engaged. At this time, the first sun gear S1 and the second sun gear S2 rotate at the same speed as for the first gear speed, Ne, in the positive direction. The first ring gear R1 and the second carrier C2 also rotate in the positive direction at the rotation speed Ne. The first carrier C1 rotates in the positive direction at the rotation speed indicated by the point of intersection of the straight line L₅ and the vertical axis that represents the rotation speed of the first carrier C1, which is the same as the rotation speed Ne of the input shaft 1. In other words, the output shaft 4 rotates at the speed N₅ in the positive direction.

The sixth gear speed is set when the first clutch K1 is disengaged from the state of the fifth gear speed, and the third clutch K3 is engaged. At this time, as a result of engaging the second clutch K2, the first ring gear R1 and the second carrier C2 rotate in the positive direction with the rotation speed Ne of the input shaft 1. Also, as a result of engaging the third clutch K3, the counter shaft 2 rotates in the opposite direction to the input shaft 1 at the rotation speed (Ne×1/r_{G1}) which is increased relative to the input shaft 1 in accordance with the gear ratio r_{G1} of the first gear train G1. Therefore, the second ring gear R2 rotates in the positive direction of the input shaft 1 at the rotation speed (Ne×1/r_{G1}×r_{G2} which is transformed relative to the third drive gear 15 in accordance with the gear ratio r_{G3} of the third gear train G3. The first carrier C1 rotates in the positive direction at the rotation speed N₆ indicated by the point of intersection of the straight line L6 and the vertical axis that represents the rotation speed of the first carrier C1. In other words, the output shaft 4 rotates at the speed N₆ in the positive direction.

The seventh gear speed is set when the third clutch K3 is disengaged from the state of the sixth gear speed, and the fourth clutch K4 is engaged. At this time, as a result of engaging the second clutch K2, the first ring gear R1 and the second carrier C2 rotate in the positive direction with the rotation speed Ne of the input shaft 1. Also, as a result of engaging the fourth clutch K4, the counter shaft 2 rotates in the opposite direction to the input shaft 1 at the rotation speed (Ne×1/r_{G2}) which is reduced relative to the input shaft 1 in accordance with the gear ratio r_{G2} of the second gear train G2. Therefore, the second ring gear R2 rotates in the positive direction of the input shaft 1 at the rotation speed (Ne×1/r_{G2}×r_{G3}) which is transformed relative to the third drive gear 15 in accordance with the gear ratio r_{G3} of the third gear train G3. The first carrier C1 rotates in the positive direction at the rotation speed N₇ indicated by the point of intersection of the straight line L₇ and the vertical axis that represents the rotation speed of the first carrier C1. In other words, the output shaft 4 rotates at the speed N₇ in the positive direction.

The eighth gear speed is set when the fourth clutch K4 is disengaged from the state of the seventh gear speed, and the first brake B1 is engaged. At this time, as a result of engaging the second clutch K2, the first ring gear R1 and the second carrier C2 rotate in the positive direction with the rotation speed Ne of the input shaft 1. The second ring R2 is held fixed and does not rotate due to the engagement of the first brake B1. The first carrier C1 rotates in the positive direction at the rotation speed N₈ indicated by the point of intersection of the straight line L₈ and the vertical axis that represents the rotation speed of the first carrier C1. In other words, the output shaft 4 rotates at the speed N₈ in the positive direction.

The first reverse gear speed (REV1) is set when the fourth clutch K4 and the second brake B2 are engaged. At this time, as a result of engaging the fourth clutch K4, the counter shaft 2 rotates in the opposite direction to the input shaft 1 at the rotation speed (Ne×1/r_{G2}) which is reduced relative to the input shaft 1 in accordance with the gear ratio r_{G2} of the second gear train G2. Therefore the second ring gear R2 rotates in the positive direction of the input shaft 1 at the speed (Ne×1/r_{G2}×r_{G3}) which is transformed relative to the third drive gear 15 in accordance with the gear ratio r_{G3} of the third gear train G3. The first ring gear R1 and the second carrier C2 are held fixed by engaging the second brake B2 and do not rotate. Therefore, the first carrier C1 rotates in the opposite direction to the input shaft 1 at the speed N_{REV1} determined by the point of intersection of the line L_{REV1} that joins these two points (B2 and K4) and the vertical axis indicating the rotation speed of the first carrier C1. In other words, the output shaft 4 rotates at the speed N_{REV1} in the reverse direction.

The second reverse gear speed (REV2) is set when the third clutch K3 and the second brake B2 are engaged. At this time, as a result of engaging the third clutch K3, the counter shaft 2 rotates in the opposite direction to the input shaft 1 at the rotation speed (Ne×1/r_{G1}) which is increased relative to the input shaft 1 in accordance with the gear ratio r_{G1} of the first gear train G1. Therefore the second ring gear R2 rotates in the positive direction of the input shaft 1 at the speed (Ne×1/r_{G1}×r_{G3}) which is transformed relative to the third drive gear 15 in accordance with the gear ratio r_{G3} of the third gear train G3. The first ring gear R1 and the second carrier C2 are held fixed by engaging the second brake B2 and do not rotate. Therefore, the first carrier C1 rotates in the opposite direction to the input shaft 1 at the speed N_{REV2} determined by the point of intersection of the line L_{REV2} that joins these two points (B2 and K3) and the vertical axis indicating the rotation speed of the first carrier C1. In other words, the output shaft 4 rotates at the speed N_{REV2} in the reverse direction.

According to the automatic transmission TM1, by combining the input side transmission unit UI and the output side transmission unit UO that includes the compound planet gear train PLA, it is possible to provide a multi-stage transmission with fewer components, so it is possible to reduce the weight of the complete transmission. Also, setting the number of gear speeds of the transmission can be freely changed by increasing or decreasing the number of gear trains in the parallel shaft type transmission PTM.

### Embodiment 2

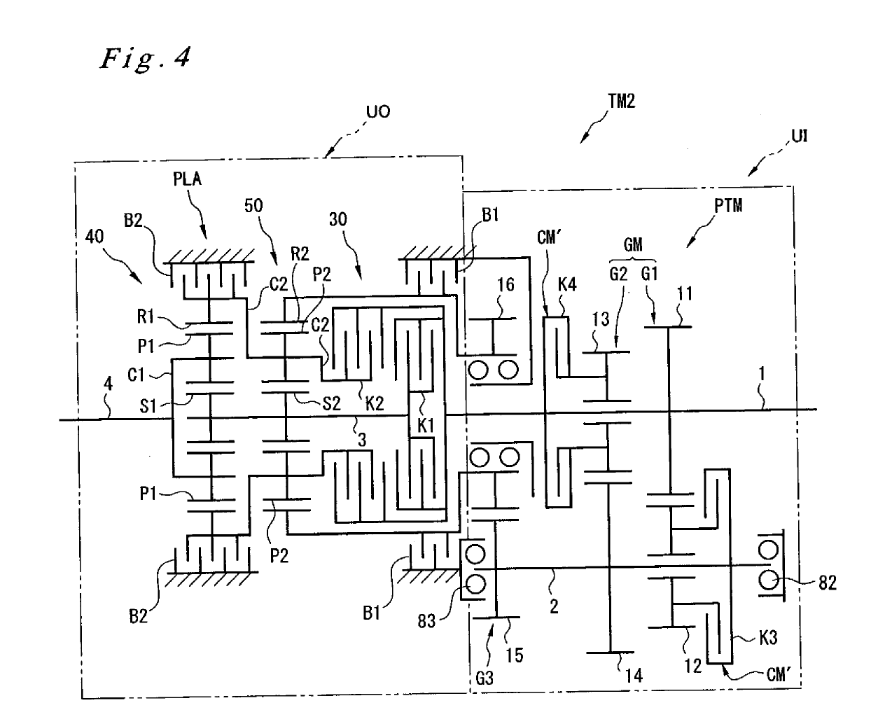

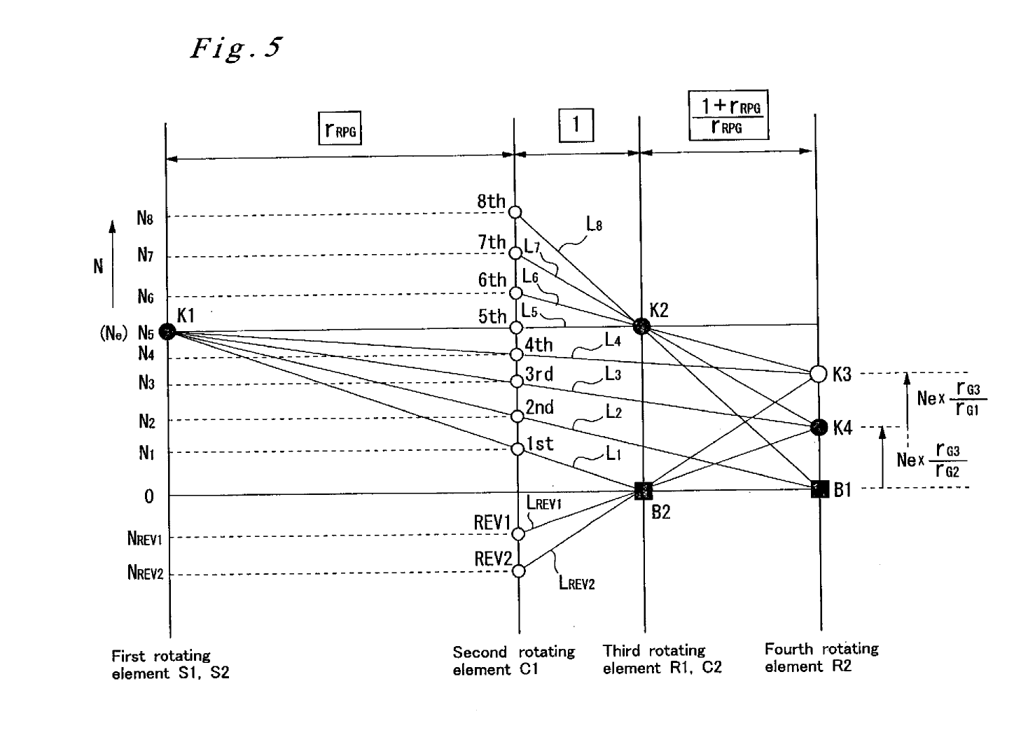

Next, an automatic transmission TM2 according to a second embodiment is explained with reference to FIGS. 4 and 5. Here, the explanation concentrates on the parts of the structure and function that differ from the automatic transmission TM1 according to the first embodiment. As shown in FIG. 4, the automatic transmission TM2 according to the second embodiment includes a parallel shaft type transmission PTM, a compound type planet gear train PLA, and planet gear engaging elements 30, the same as for the automatic transmission TM1 according to the first embodiment. The compound type planet gear train PLA, and the planet gear engaging elements 30 in the automatic transmission TM2 are the same as for the automatic transmission TM1 according to the first embodiment described above. However, the structure of the parallel shaft type transmission PTM is different.

As shown in FIG. 4, the parallel shaft type transmission PTM includes an input shaft side gear train GM that includes a first gear train G1, a second gear train G2, and a third gear train G3. The gear ratios r_{G1}, r_{G2}, r_{G3} of each gear train G1 through G3 are obtained by dividing the number of gear teeth on the counter shaft 2 side by the number of gear teeth on the input shaft side 1, respectively. Here, the gear ratios r_{G1}, r_{G3} of the first and third gear trains G1, G3 are set to be smaller than one, and the gear ratio r_{G2} of the second gear train G2 is set to be greater than one, the same as for the first embodiment.

The first gear train G1 includes a first drive gear 11 connected to the input shaft 1 that can rotate integrally with the input shaft 1, and a first driven gear 12 that meshes with the first drive gear 11 and that is provided on the counter shaft 2 and can rotate relative to the counter shaft 2. The first driven gear 12 can be freely engaged with and disengaged from the counter shaft 2 by a third clutch K3 that is provided on the counter shaft 2 and that rotates integrally with the counter shaft 2. When the third clutch K3 is engaged, the counter shaft 2 rotates in the opposite direction to the input shaft 1 with the speed (Ne×1/r_{G1}) which is increased relative to the input shaft 1 in accordance with the gear ratio r_{G1} of the first gear train G1.

The second gear train G2 includes a second drive gear 13 provided on the input shaft 1 that can rotate relative to the input shaft 1, and a second driven gear 14 that meshes with the second drive gear 13 and is connected to the counter shaft 2 and can rotate integrally with the counter shaft 2. The second drive gear 13 can be freely engaged with and disengaged from the input shaft 1 by a fourth clutch K4 provided on the input shaft 1 and that rotates integrally with the input shaft 1. When the fourth clutch K4 is engaged, the counter shaft 2 rotates in the opposite direction to the input shaft 1 at the speed (Ne×1/r_{G2}) which is reduced relative to the input shaft 1 in accordance with the gear ratio r_{G2} of the second gear train G2.

The third gear train G3 includes a third drive gear 15 provided on the counter shaft 2 capable of rotating integrally with the counter shaft 2, and a third driven gear 16 that meshes with the third drive shaft 15 and that is provided on the input shaft 1 and can rotate relative to the input shaft 1. The third driven gear 16 rotates at the rotation speed (Nc×r_{G3}) which is reduced relative to the counter shaft 2 in accordance with the gear ratio r_{G3} of the third gear train G3, in the opposite direction to the counter shaft 2, in other words in the same direction as the input shaft 1. The third driven gear 16 is connected to the second ring gear R2.

The input side gear engaging element CM′ includes the third and fourth clutches K3, K4. The third clutch K3 is provided on the counter shaft 2, and the fourth clutch K4 is provided on the input shaft 1.

By carrying out control by the gear change control device to selectively engage the frictional engaging elements K1 through K4, B1, B2 as shown in Table 2, the automatic transmission TM2 structured as described above can set eight forward gear speeds (1^{st} through 8^{th}) and two reverse speeds (REV1, REV2). The symbol in Table 2 indicates that the frictional engagement element is in the engaged state. Each gear speed is set by engaging two frictional engaging elements.

TABLE 2

| | K1 | K2 | K3 | K4 | B1 | B2 |
|---|---|---|---|---|---|---|
| R2 | | | | | | |
| R1 | | | | | | |
| 1 | | | | | | |
| 2 | | | | | | |
| 3 | | | | | | |
| 4 | | | | | | |
| 5 | | | | | | |
| 6 | | | | | | |
| 7 | | | | | | |
| 8 | | | | | | |

FIG. 5 shows the velocity diagram of the compound planet gear train PLA according to the present embodiment. The four vertical axes indicate the rotation speed N of, from the left, the first and second sun gears S1, S2, the first carrier C1, the first ring gear R1 and the second carrier C2, and the second ring gear R2, respectively, these elements constituting a compound planet gear train PLA. The symbol and the ∘symbol on the vertical axes for the first rotational element, the third rotational element, and the fourth rotational element indicate engagement of a clutch. Of these, the ∘ symbol indicates a clutch installed on the counter shaft 2 side.

For the first through third, fifth, seventh, and eighth forward gear speeds, and the first (REV1) and second (REV2) reverse gear speeds, the state of engagement or disengagement of the first through fourth clutches K1 through K4, and the first and second brakes B1, B2, and the rate of revolution of the first carrier C1, in other words, the rate of rotation of the output shaft 4, are all the same as for the first embodiment described above.

The fourth gear speed is set by engaging the first clutch K1 and the third clutch K3. At this time, the first sun gear S1 and the second sun gear S2 rotate in the positive direction of the input shaft 1 at the same rotation speed Ne as the input shaft 1. As a result of engaging the third clutch K3, the counter shaft 2 rotates in the opposite direction to the input shaft 1 at the speed (Ne×1/r_{G1}×r_{G3}) which is increased relative to the input shaft 1 in accordance with gear ratio r_{G1} of the first gear train G1. Therefore, the second ring gear R2 rotates in the positive direction of the input shaft 1 at the speed (Ne×1/r_{G1}×r_{G3}) which is transformed relative to the third drive gear 15 in accordance with the gear ratio r_{G3} of the third gear train G3. Therefore, the first ring gear R1 and the second carrier C2 rotate in the positive direction at a speed indicated by the point of intersection of the straight line L₄ and the vertical axis representing the rotation speed of the first ring gear R1 and the second carrier C2. The first carrier C1 rotates in the positive direction at the rotation speed N₄ indicated by the point of intersection of the straight line L₄ and the vertical axis that represents the rotation speed of the first carrier C1. In other words, the output shaft 4 rotates at the speed N₄ in the positive direction.

The sixth gear speed is set by engaging the second clutch K2 and the third clutch K3. At this time, the first ring gear R1 and the second carrier C2 rotate in the positive direction of the input shaft 1 at the rotation speed Ne of the input shaft 1. Also, as a result of engaging the third clutch K3, the counter shaft 2 rotates in the opposite direction to the input shaft 1 at the rotation speed (Ne×1/r_{G1}) which is increased relative to the input shaft 1 in accordance with the gear ratio r_{G1} of the first gear train G1. Therefore, the second ring gear R2 rotates in the positive direction of the input shaft 1 at the rotation speed (Ne×1/r_{G1}×r_{G2}) which is transformed relative to the third drive gear 15 corresponding to the gear ratio r_{G3} of the third gear train G3. The first carrier C1 rotates in the positive direction at the rotation speed N₆ indicated by the point of intersection of the straight line L₆ and the vertical axis that represents the rotation speed of the first carrier C1. In other words, the output shaft 4 rotates at the speed N₆ in the positive direction.

### Embodiment 3

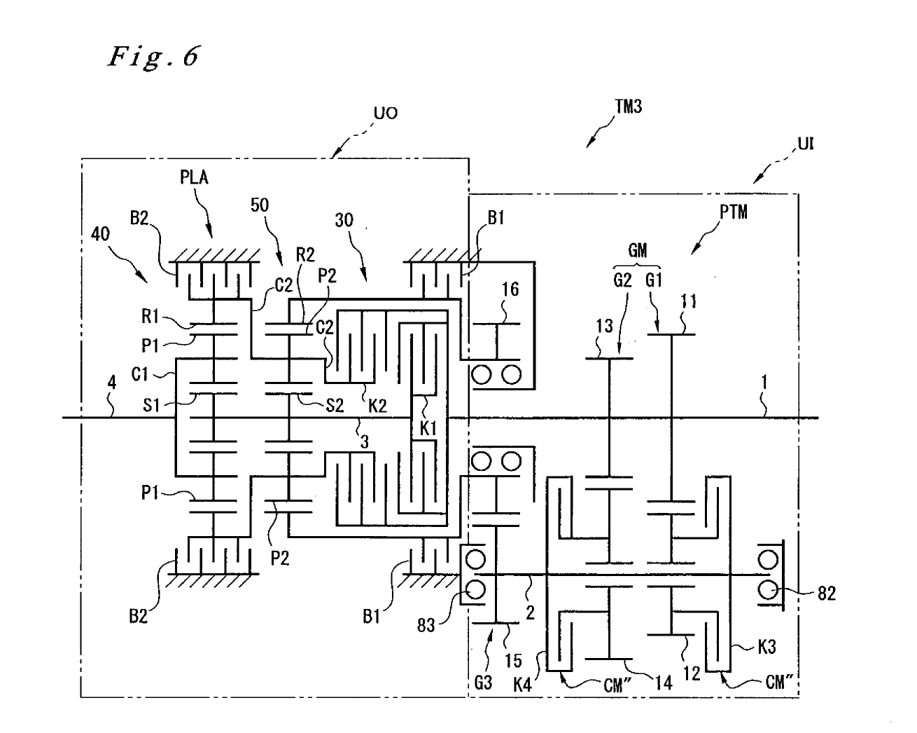

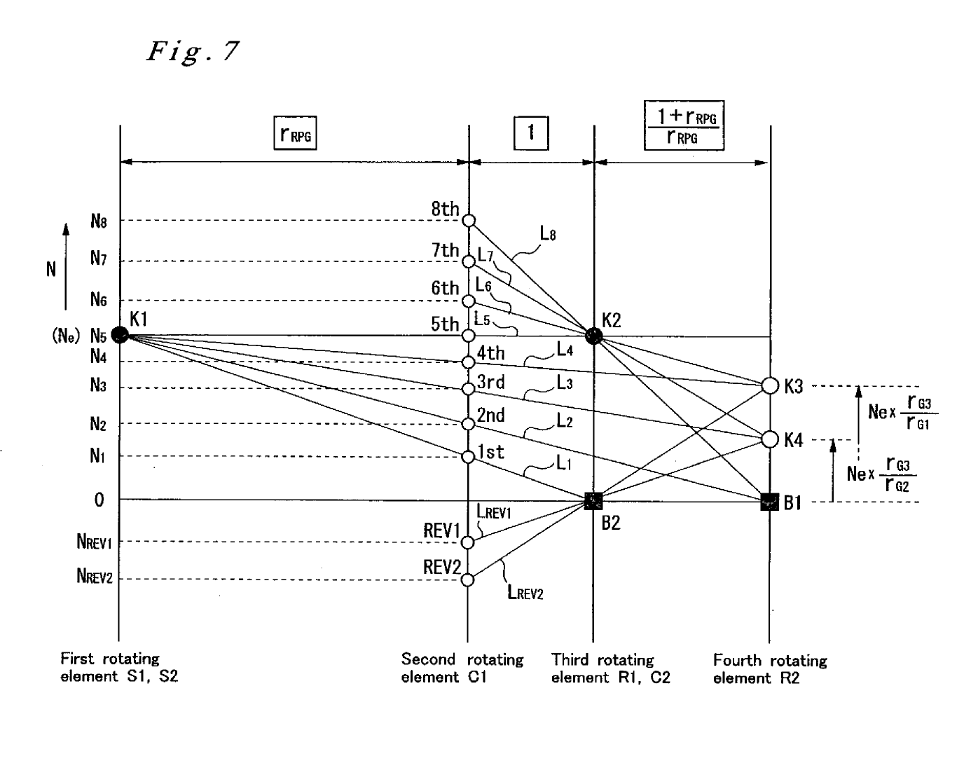

Next, an automatic transmission TM3 according to a third embodiment is explained with reference to FIGS. 6 and 7. Here, the explanation concentrates on the parts of the structure and function that differ from the automatic transmission TM1 according to the first embodiment. As shown in FIG. 6, the automatic transmission TM3 according to the third embodiment includes a parallel shaft type transmission PTM, a compound planet gear train PLA, and planet gear engaging elements 30, the same as for the automatic transmission TM1 according to the first embodiment.

The compound type planet gear train PLA, and the planet gear engaging elements 30 in the automatic transmission TM3 are the same as for the automatic transmission TM1 according to the first embodiment described above, but the structure of the parallel shaft type transmission PTM is different.

As shown in FIG. 6, the parallel shaft type transmission PTM includes an input shaft side gear train GM that includes a first gear train G1, a second gear train G2, and a third gear train G3. The gear ratios r_{G1}, r_{G2}, r_{G3} of each gear train G1 through G3 are obtained by dividing the number of gear teeth on the driven gear by the number of gear teeth on the drive gear, respectively. Here, the gear ratios r_{G1}, r_{G3} of the first and third gear trains G1, G3 are set to be smaller than one, and the gear ratio r_{G2} of the second gear train G2 is set to be greater than one.

The first gear train G1 includes a first drive gear 11 connected to the input shaft 1 that can rotate integrally with the input shaft 1, and a first driven gear 12 that meshes with the first drive gear 11 and that is provided on the counter shaft 2 and can rotate relative to the counter shaft 2. The first driven gear 12 can be freely engaged with and disengaged from the counter shaft 2 by a third clutch K3 that is provided on the counter shaft 2 and that rotates integrally with the counter shaft 2. When the third clutch K3 is engaged, the counter shaft 2 rotates in the opposite direction to the input shaft 1 with the speed (Ne×1/r_{G1}), which is increased relative to the input shaft 1 in accordance with the gear ratio r_{G1} of the first gear train G1.

The second gear train G2 includes a second drive gear 13 connected to the input shaft 1 that rotates integrally with the input shaft 1, and a second driven gear 14 that meshes with the second drive gear 13 and is provided on the counter shaft 2 and can rotate relative to the counter shaft 2. The second driven gear 14 can be freely engaged with and disengaged from the counter shaft 2 by a fourth clutch K4 provided on the counter shaft 2 and that rotates integrally with the counter shaft 2. When the fourth clutch K4 is engaged, the counter shaft 2 rotates in the opposite direction to the input shaft 1 at the speed (Ne×1/r_{G2}) which is reduced relative to the input shaft 1 in accordance with the gear ratio r_{G2} of the second gear train G2.

The third gear train G3 includes a third drive gear 15 provided on the counter shaft 2 and capable of rotating integrally with the counter shaft 2, and a third driven gear 16 that meshes with the third drive gear 15 and that is provided on the input shaft 1 and can rotate relative to the input shaft 1. The third driven gear 16 rotates at the rotation speed (Nc×r_{G3}) which is reduced relative to the counter shaft 2 in accordance with the gear ratio r_{G3} of the third gear train G3, in the opposite direction to the counter shaft 2, in other words in the same direction as the input shaft 1. The third driven gear 16 is connected to the second ring gear R2.

The input side gear engaging element CM″ includes the third and fourth clutches K3, K4. The third clutch K3 and the fourth clutch K4 are both provided on the counter shaft 2.

By carrying out control by the gear change control device to selectively engage the frictional engaging elements K1 through K4, B1, B2 as shown in Table 3, the automatic transmission TM3 structured as described above can set eight forward gear speeds (1^{st} through 8^{th}) and two reverse speeds (REV1, REV2). The symbol in Table 3 indicates that the frictional engaging element is in the engaged state. Each gear speed is set by engaging two frictional engaging elements.

TABLE 3

| | K1 | K2 | K3 | K4 | B1 | B2 |
|---|---|---|---|---|---|---|
| R2 | | | | | | |
| R1 | | | | | | |
| 1 | | | | | | |
| 2 | | | | | | |
| 3 | | | | | | |
| 4 | | | | | | |
| 5 | | | | | | |
| 6 | | | | | | |
| 7 | | | | | | |
| 8 | | | | | | |

FIG. 7 shows the velocity diagram of the compound planet gear train PLA according to the present embodiment. The four vertical axes indicate the rotation speed N of, from the left, the first and second sun gears S1, S2, the first carrier C1, the first ring gear R1 and the second carrier C2, and the second ring gear R2, respectively, these elements constituting the compound planet gear train PLA. The symbol and the ∘ symbol on the vertical axes for the first rotational element, the third rotational element, and the fourth rotational element indicate engagement of a clutch. Of these, the ∘ symbol indicates a clutch installed on the counter shaft 2 side.

For the first, second, fifth, and eighth forward gear speeds, the state of engagement or disengagement of the first through fourth clutches K1 through K4, and the first and second brakes B1, B2, and the rate of revolution of the first carrier C1, in other words, the rate of rotation of the output shaft 4, are the same as the first embodiment described above.

The third gear speed is set by engaging the first clutch K1 and the fourth clutch K4. At this time, the first sun gear S1 and the second sun gear S2 rotate at the same speed as for the first gear speed, Ne, in the positive direction. As a result of engaging the fourth clutch K4, the counter shaft 2 rotates in the opposite direction to the input shaft 1 at the rotation speed (Ne×1/r_{G2}) which is reduced relative to the input shaft 1 in accordance with the gear ratio r_{G2} of the second gear train G2. Therefore, the second ring gear R2 rotates in the positive direction of the input shaft 1 at the rotation speed (Ne×1/r_{G2}×r_{G3}) which is transformed relative to the third drive gear 15 in accordance with the gear ratio r_{G3} of the third gear train G3. Therefore, the first ring gear R1 and the second carrier C2 rotate in the positive direction at a speed indicated by the point of intersection of the straight line L₃ and the vertical axis representing the rotation speed of the first ring gear R1 and the second carrier C2. The first carrier C1 rotates in the positive direction at the rotation speed N₃ indicated by the point of intersection of the straight line L₃ and the vertical axis that represents the rotation speed of the first carrier C1. In other words, the output shaft 4 rotates at the speed N₃ in the positive direction.

The fourth gear speed is set when the fourth clutch K4 is disengaged from the state of the third gear speed, and the third clutch K3 is engaged. At this time, the first sun gear S1 and the second sun gear S2 rotate at the same speed as for the first gear speed, Ne, in the positive direction. As a result of engaging the third clutch K3, the counter shaft 2 rotates in the opposite direction to the input shaft 1 at the rotation speed (Ne×1/r_{G1}) which is increased relative to the input shaft 1 in accordance with the gear ratio r_{G1} of the first gear train G1. The second ring gear R2 rotates in the positive direction of the input shaft 1 at the rotation speed (Ne×1/r_{G1}×r_{G3}) which is transformed relative to the third drive gear 15 in accordance with the gear ratio r_{G3} of the third gear train G3. Therefore, the first ring gear R1 and the second carrier C2 rotate in the positive direction at a speed indicated by the point of intersection of the straight line L₁ and the vertical axis representing the rotation speed of the first ring gear R1 and the second carrier C2. The first carrier C1 rotates in the positive direction at the rotation speed N₄ indicated by the point of intersection of the straight line L₄ and the vertical axis that represents the rotation speed of the first carrier C1. In other words, the output shaft 4 rotates at the speed N₄ in the positive direction.

The sixth gear speed is set by engaging the second clutch K2 and the third clutch K3. At this time, the first ring gear R1 and the second carrier C2 rotate in the positive direction with the rotation speed Ne of the input shaft 1. As a result of engaging the third clutch K3, the counter shaft 2 rotates in the opposite direction to the input shaft 1 at the rotation speed (Ne×1/r_{G1}) which is increased relative to the input shaft 1 in accordance with the gear ratio r_{G1} of the first gear train G1. Therefore, the second ring gear R2 rotates in the positive direction of the input shaft 1 at the rotation speed (Ne×1/r_{G1}×r_{G3}) which is transformed relative to the third drive gear 15 in accordance with the gear ratio r_{G3} of the third gear train G3. The first carrier C1 rotates in the positive direction at the rotation speed N6 indicated by the point of intersection of the straight line L6 and the vertical axis that represents the rotation speed of the first carrier C1. In other words, the output shaft 4 rotates at the speed N₆ in the positive direction.

The seventh gear speed is set when the third clutch K3 is disengaged from the state of the sixth gear speed, and the fourth clutch K4 is engaged. At this time, the first ring gear R1 and the second carrier C2 rotate in the positive direction with the rotation speed Ne of the input shaft 1. As a result of engaging the fourth clutch K4, the counter shaft 2 rotates in the opposite direction to the input shaft 1 at the rotation speed (Ne×1/r_{G2}) which is reduced relative to the input shaft 1 in accordance with the gear ratio r_{G2} of the second gear train G2. The second ring gear R2 rotates in the positive direction of the input shaft 1 at the rotation speed (Ne×1/r_{G1}×r_{G3}) which is transformed relative to the third drive gear 15 in accordance with the gear ratio r_{G3} of the third gear train G3. The first carrier C1 rotates in the positive direction at the rotation speed N₇ indicated by the point of intersection of the straight line L₇ and the vertical axis that represents the rotation speed of the first carrier C1. In other words, the output shaft 4 rotates at the speed N7 in the positive direction.

The first reverse gear speed (REV1) is set when the fourth clutch K4 and the second brake B2 are engaged. At this time, as a result of engaging the fourth clutch K4, the counter shaft 2 rotates in the opposite direction to the input shaft 1 at the rotation speed (Ne×1/r_{G2}) which is reduced relative to the input shaft 1 in accordance with the gear ratio r_{G2} of the second gear train G2. The second ring gear R2 rotates in the positive direction of the input shaft 1 at the speed (Ne×1/r_{G1}×r_{G3}) which is transformed relative to the third drive gear 15 in accordance with the gear ratio r_{G3} of the third gear train G3. The first ring gear R1 and the second carrier C2 are held fixed by engaging the second brake B2 and do not rotate. Therefore, the first carrier C1 rotates in the opposite direction to the input shaft 1 at the speed N_{REV1} determined by the point of intersection of the line L_{REV1} that joins these two points (B2 and K4) and the vertical axis indicating the rotation speed of the first carrier C1. In other words, the output shaft 4 rotates at the speed N_{REV1} in the reverse direction.

The second reverse gear speed (REV2) is set when the third clutch K3 and the second brake B2 are engaged. At this time, as a result of engaging the third clutch K3, the counter shaft 2 rotates in the opposite direction to the input shaft 1 at the rotation speed (Ne×1/r_{G1}) which is increased relative to the input shaft 1 in accordance with the gear ratio r_{G1} of the first gear train G1. The second ring gear R2 rotates in the positive direction of the input shaft 1 at the speed (Ne×1/r_{G1}×r_{G3}) which is transformed relative to the third drive gear 15 in accordance with the gear ratio r_{G3} of the third gear train G3. The first ring gear R1 and the second carrier C2 are held fixed by engaging the second brake B2 and do not rotate. Therefore, the first carrier C1 rotates in the opposite direction to the input shaft 1 at the speed N_{REV2} determined by the point of intersection of the line L_{REV2} that joins these two points (B2 and K3) and the vertical axis indicating the rotation speed of the first carrier C1. In other words, the output shaft 4 rotates at the speed N_{REV2} in the reverse direction.

### Embodiment 4

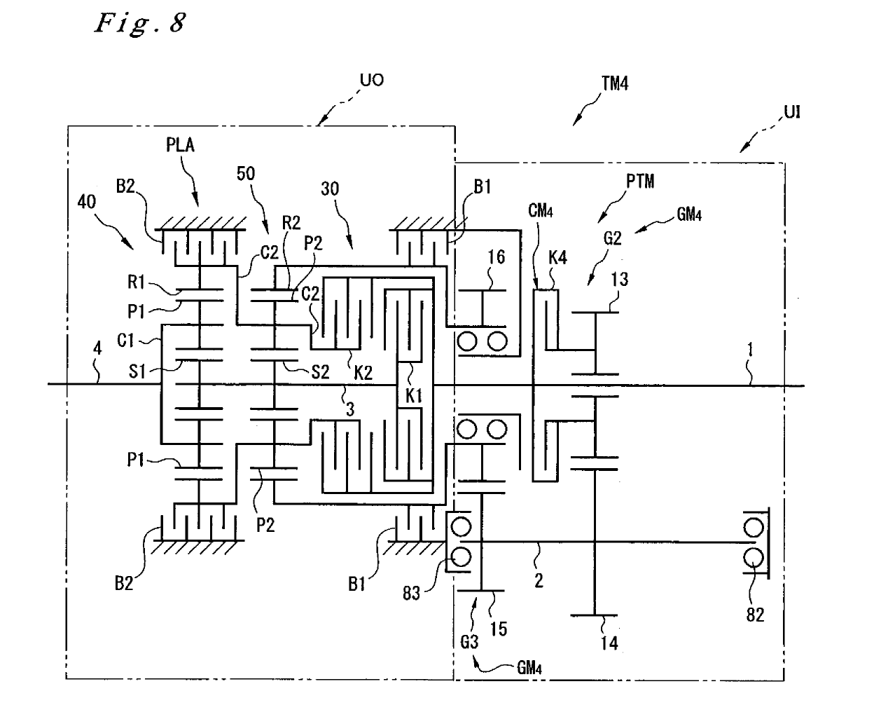

Next, an automatic transmission TM4 according to a fourth embodiment is explained with reference to FIGS. 8 through 12. Here, the explanation concentrates on the parts of the structure and function that differ from the automatic transmission TM1 according to the first embodiment. As shown in FIG. 8, the automatic transmission TM4 according to the fourth embodiment includes a parallel shaft type transmission PTM, a compound type planet gear train PLA, and planet gear engaging elements 30, the same as for the automatic transmission TM1 according to the first embodiment.

The compound type planet gear train PLA, and the planet gear engaging elements 30 in the automatic transmission TM4 are the same as for the automatic transmission TM1 according to the first embodiment described above. However, the structure of the parallel shaft type transmission PTM is different.

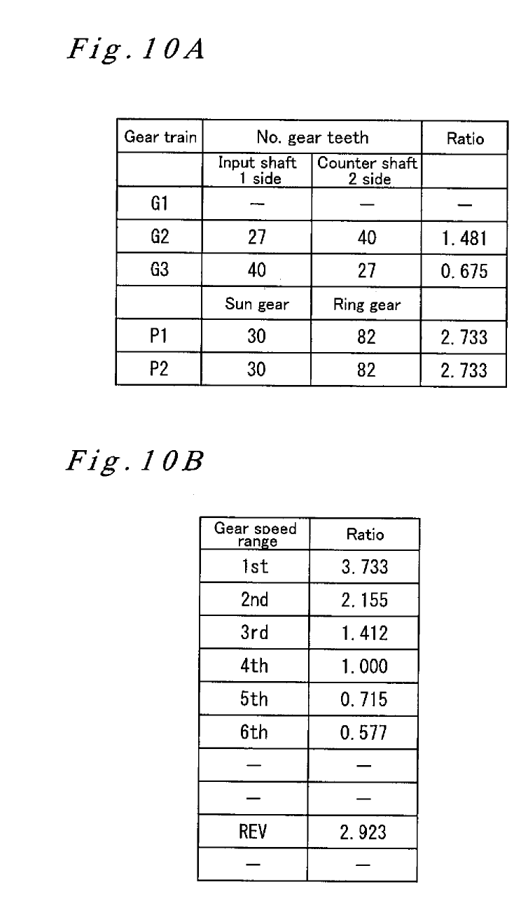

As shown in FIG. 8, the parallel shaft type transmission PTM includes an input shaft side gear train GM₄ that includes a second gear train G2, and a third gear train G3. In other words, the input shaft side gear train GM₄ is structured as the input shaft side gear train GM of the automatic transmission TM1 without the first gear train G1. Here the case where the second gear train G2 and the third gear train G3 are provided is explained. As shown in FIG. 10A, the gear ratio r_{G2} of the second gear train G2 is set larger than one, and the gear ratio r_{G3} of the third gear train G3 is set smaller than one.

The second gear train G2 includes a first drive gear 13 provided on the input shaft 1 that can rotate relative to the input shaft 1, and a first driven gear 14 that meshes with the first drive gear 13 and is provided on the counter shaft 2 and can rotate integrally with the counter shaft 2. The first drive gear 13 can be freely engaged with and disengaged from the input shaft 1 by a fourth clutch K4 provided on the input shaft 1 and that rotates integrally with the input shaft 1. When the fourth clutch K4 is engaged, the counter shaft 2 rotates in the opposite direction to the input shaft 1 at the speed (Ne×1/r_{G2}) which is reduced relative to the input shaft 1 in accordance with the gear ratio r_{G2} of the second gear train G2.

The third gear train G3 includes a second drive gear 15 connected to the counter shaft 2 and capable of rotating integrally with the counter shaft 2, and a second driven gear 16 that meshes with the second drive gear 15 and that is provided on the input shaft 1 and can rotate relative to the input shaft 1. The second driven gear 16 rotates at the rotation speed (Nc×r_{G3}) which is reduced relative to the counter shaft 2 in accordance with the gear ratio r_{G3} of the third gear train G3, in the opposite direction to the counter shaft 2, in other words in the same direction as the input shaft 1. The second driven gear 16 is connected to the second ring gear R2.

The input side gear engaging element CM₄ includes the fourth clutch K4. The fourth clutch K4 is provided on the input shaft 1.

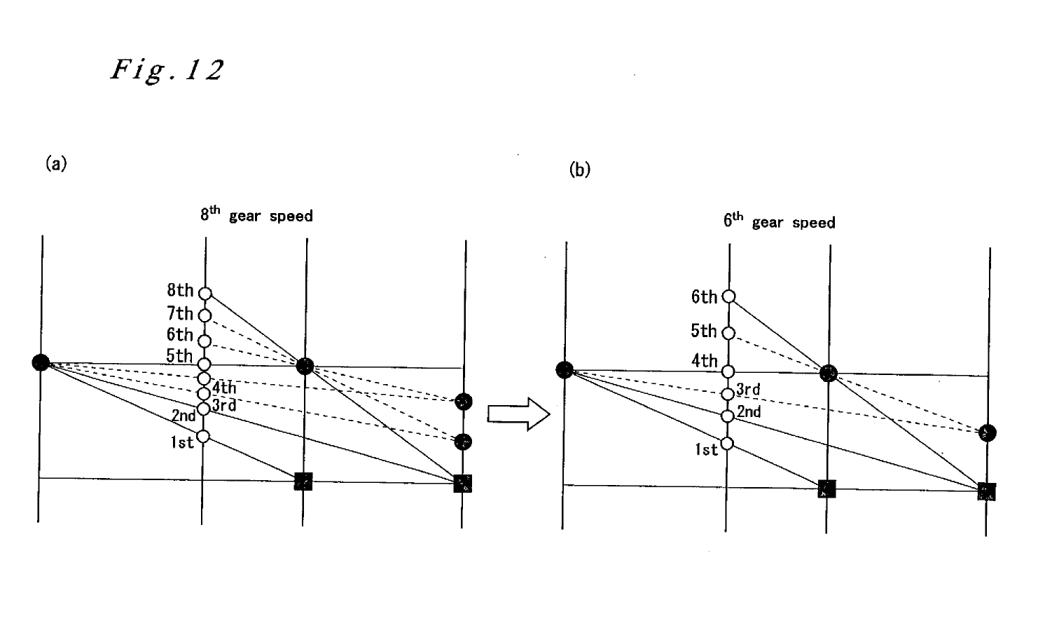

By carrying out control by the gear change control device to selectively engage the frictional engaging elements K1, K2, K4, B1, B2 as shown in Table 4, the automatic transmission TM4 structured as described above can set six forward gear speeds (1^{st} through 6^{th}) and one reverse speed (REV). The velocity diagram for this case is shown in FIG. 12. By omitting a single gear train (G1) from the structure of the automatic transmission TM1, in FIG. 12(a) the clutch K3 which engages and disengages the gears forming the gear train G1 is omitted, to give the six speed velocity diagram as shown in FIG. 12(b).

TABLE 4

| | K1 | K2 | K4 | B1 | B2 |
|---|---|---|---|---|---|
| R | | | | | |
| 1 | | | | | |
| 2 | | | | | |
| 3 | | | | | |
| 4 | | | | | |
| 5 | | | | | |
| 6 | | | | | |

The ratios (speed reduction ratios) of each gear speed set as shown in Table 4 vary according to the number of teeth set in each gear. However, FIG. 10B shows an example of these ratios. FIG. 9B shows, for comparison, the automatic transmission TM1 according to the first embodiment. Here, the ratio range of the automatic transmission TM4, expressed as the ratio of the ratios at the sixth speed and the first speed, is 6.466 using the values in FIG. 10B. On the other hand, the ratio range of the automatic transmission TM1, expressed as the ratio of the ratios at the eighth speed and the first speed, is 6.466 using the values in FIG. 9B. The preferred ratio range is generally between 6 and 7. When the automatic transmission TM1 (8 speed) is changed to the automatic transmission TM4 (6 speed), by simply changing the ratio of the gear train G2 (as shown in FIGS. 9(a) and 10(a), the ratio for the gear train G2 is changed from 1.792 to 1.481), it is possible to change to the automatic transmission TM4 while preserving the preferred ratio range.

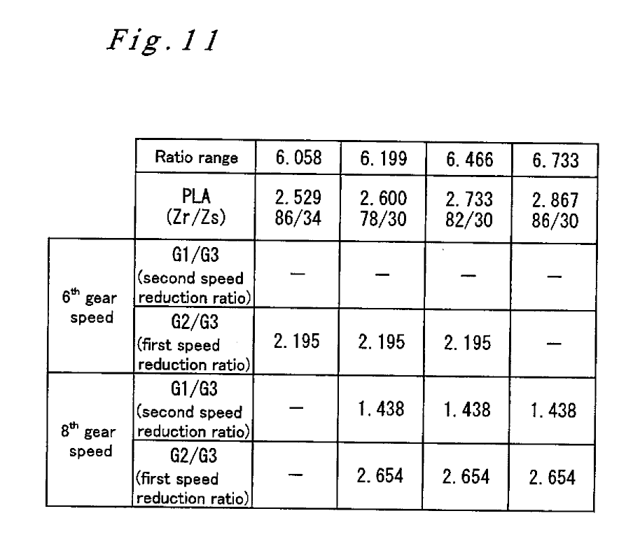

In the present embodiment, as shown in FIG. 11, even if the ratio of the compound planet gear train PLA varies, it is possible to configure automatic transmissions having six or eight speeds having the preferable 6 to 7 ratio range. In FIGS. 9(a) and 10(a), the ratio of the compound planet gear train PLA is 2.733, and the ratio range is 6.466. However, in the case that the ratio of the compound planet gear train PLA is 2.600, it is possible to configure automatic transmissions with a ratio range 6.199 for both six speed and eight speed automatic transmissions. Also, when the ratio of the compound planet gear train PLA is 2.529, it is possible to configure a six speed automatic transmission with a ratio range of 6.058. Also, when the ratio of the compound planet gear train PLA is 2.867, it is possible to configure an eight speed automatic transmission with a ratio range of 6.733.

In this way, in the present embodiment, by just changing the structure of the gear trains in the parallel shaft type transmission PTM, it is possible to change the automatic transmission TM1 having eight speeds into the automatic transmission TM4 having six speeds. In other words, to change an automatic transmission having eight speeds into an automatic transmission having six speeds, just one gear train (G1) may be eliminated from the structure of the automatic transmission TM1, without changing the structure of the compound planet gear train PLA. In this way, by having components in common between the automatic transmission TM1 and the automatic transmission TM4, it is possible to reduce the cost of changing the automatic transmission TM1 to the automatic transmission TM4.

In the present embodiment, the example of changing the automatic transmission TM1 having eight gear speeds into the automatic transmission TM4 having six gear speeds has been explained. However, this is just an example of a modification, and the present embodiment is not limited to this. For example, if one new gear train GM is added to the parallel shaft type transmission PTM of the automatic transmission TM1 having eight gear speeds, it is possible to form a transmission having 10 gear speeds, and if two new gear trains GM are added to the parallel shaft type transmission PTM of the automatic transmission TM1 having eight gear speeds, it is possible to form a transmission having 12 gear speeds. In this way, by adding N new gear trains GM to the parallel shaft type transmission PTM of the automatic transmission TM1 having eight gear speeds, it is possible to form a transmission having (8+2N) gear speeds. This is a simpler structure than the case where the upstream side of the transmission is formed with planet gear trains, which contributes to cost reduction.

### Embodiment 5

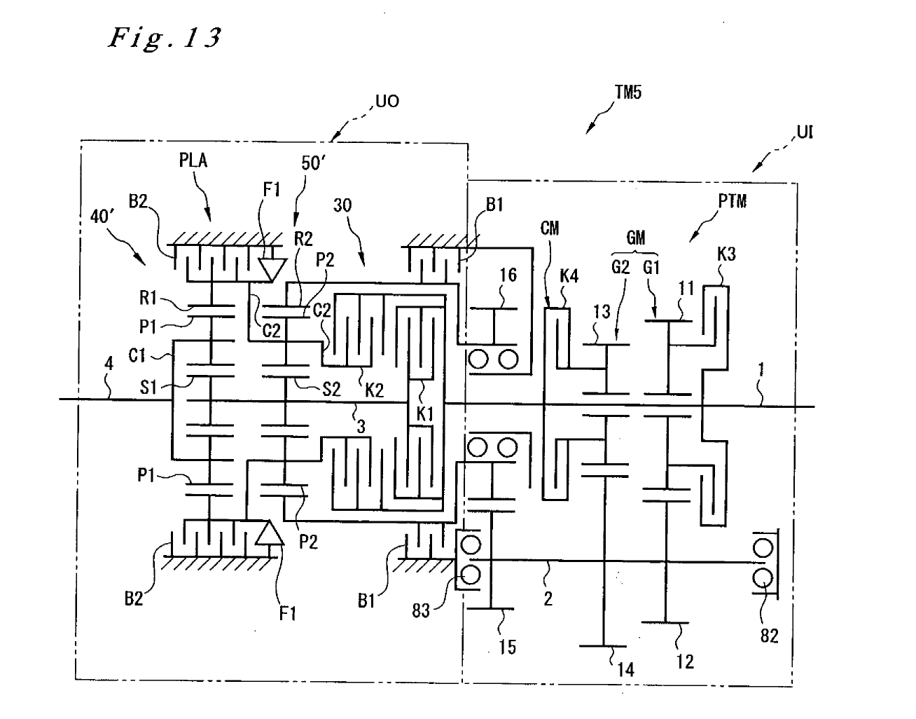

Next, an automatic transmission TM5 according to a fifth embodiment is explained with reference to FIG. 13. Here, the explanation concentrates on the parts of the structure and function that differ from the automatic transmission TM1 according to the first embodiment. As shown in FIG. 13, the automatic transmission TM5 according to the fifth embodiment includes a parallel shaft type transmission PTM, a compound type planet gear train PLA, and planet gear engaging elements 30, the same as for the automatic transmission TM1 according to the first embodiment. The parallel shaft type transmission PTM, and planet gear engaging elements 30 in the automatic transmission TM5 are the same as for the automatic transmission TM1 according to the first embodiment described above, but the structure of the compound type planet gear train PLA is different.

The compound type planet gear train PLA includes a first planet gear train 40′ and a second planet gear train 50′ structured as described below.

The first planet gear train 40′ includes a first sun gear S1 installed on the center shaft 3 capable of rotating about an axis of rotation located in the center shaft 3; a first pinion gear P1 that meshes with the first sun gear S1 and that rotates while revolving about the first sun gear S1; a first carrier C1 that rotatably supports the first pinion gear P1 via a needle bearing, that is fixed to the output shaft 4 and that rotates about the output shaft 4 as center or revolution at the same speed as the first pinion gear P1; and a first ring gear R1 that meshes with the first pinion gear P1, that has internal gear teeth, and that is capable of rotating about an axis of rotation that is on the same axis as the axis of rotation of the first sun gear S1. When the first clutch K1 is engaged, the rotation of the input shaft 1 is directly transmitted to the first carrier C1 via the center shaft 3.

The second planet gear train 50′ includes a second sun gear S2 installed on the center shaft 3 and that is capable of rotating about an axis of rotation that is on the same axis of rotation as the center shaft 3; a second pinion gear P2 that meshes with the second sun gear S2 and that rotates while revolving about the second sun gear S2; a second carrier C1 that rotatably supports the second pinion gear P2 via a needle bearing, and that revolves about the center shaft 3 as the center of revolution at the same speed as the second pinion gear P2; and a second ring gear R2 that meshes with the second pinion gear P2, that has internal gear teeth, and that is capable of rotating about an axis of rotation that is on the same axis as the axis of rotation of the second sun gear S2.

The first ring gear R1 is provided integral with the second carrier C2, and rotates integrally with the second carrier C2. In addition the first ring gear R1 can be held fixed together with the second carrier C2 by the second brake B2. Also, the second pinion gear P2 is connected so that it can be freely engaged with and disengaged from the input shaft 1 via the second clutch K2. Furthermore, the second carrier C2 and the first ring gear R1 are connected to the casing 20 via a one way brake F1. The one way brake F1 acts only in respect of rotation in the forward drive direction, By carrying out control by a gear change control device to selectively engage the frictional engaging elements K1 through K4, B1, B2, and F1 as shown in Table 5, the automatic transmission TM5 structured as described above can set eight forward gear speeds (1^{st} through 8^{th}) and two reverse speeds (REV1, REV2).

TABLE 5

| | K1 | K2 | K3 | K4 | B1 | B2 | F1 |
|---|---|---|---|---|---|---|---|
| R2 | | | | | | | |
| R1 | | | | | | | |
| 1 | | | | | | ◯ | |
| 2 | | | | | | | |
| 3 | | | | | | | |
| 4 | | | | | | | |
| 5 | | | | | | | |
| 6 | | | | | | | |
| 7 | | | | | | | |
| 8 | | | | | | | |

In Table 5, in the first gear speed the second brake B2 is indicated as o. This indicates that even if the second brake B2 is not engaged, it is possible to set the first gear speed by the action of the one way brake F1. The one way brake F1 is installed to control the tendency of the first ring gear R1 to rotate in the opposite direction to the first sun gear S1 in the first gear speed. When the first sun gear S1 rotates, the rotation is transmitted to the first ring gear R1 via the first pinion gear P1. However, at this time a torque acts to rotate the first ring gear R1 in the opposite direction to the first sun gear S1. Here, by restricting the first ring gear R1 from rotating in this direction by the one way brake F1, the first ring gear R1 is held fixed, and power is transmitted to the output shaft 4 so that the output shaft 4 rotates in the same direction as the input shaft 1. Apart from the first gear speed, the first ring gear R1 rotates in the same direction as the first sun gear S1, so restriction of rotation by the one way brake F1 does not occur.

When a torque acts on the output shaft 4 that tends to rotate the output shaft 4 in the direction opposite to the input shaft 1, the first ring gear R1 rotates in the same direction as the first sun gear S1. However, in this case the one way brake F1 does not restrict the rotation of the first ring gear R1. Rotation of the first ring gear R1 is allowed, so the first ring gear R1 freely rotates, so power is not transmitted from the input shaft 1 side to the output shaft 4 side. In this way, by preventing power transmission in the direction of rotation that is opposite to the direction of rotation of the input shaft 1 by the one way brake F1, it is possible to restrain the reduction in rate of rotation of the output shaft 4 when shifting down. Therefore, it is possible to prevent application of the engine brake when the gear speed is set to the first gear speed. Also, it is possible to hold fixed the first ring gear R1 by the second brake B2, and restrict power transmission in the opposite direction to the direction of rotation of the input shaft 1 by the one way brake F1. Therefore, it is possible to implement the change between the first and second gear speeds by just holding fixed or releasing with the first brake B1 (holding fixed or releasing with the second brake B2 is not necessary). Therefore, controllability can be improved.

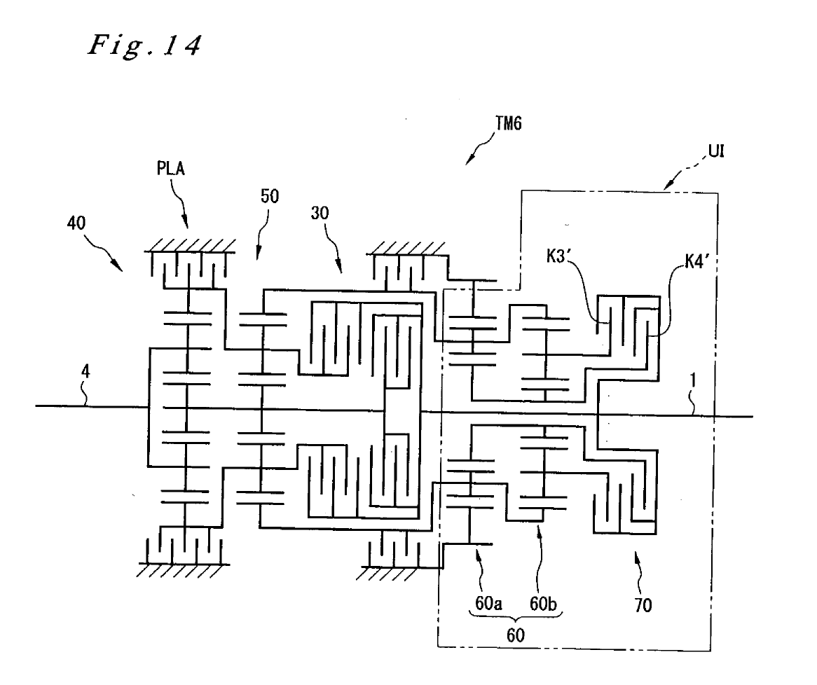

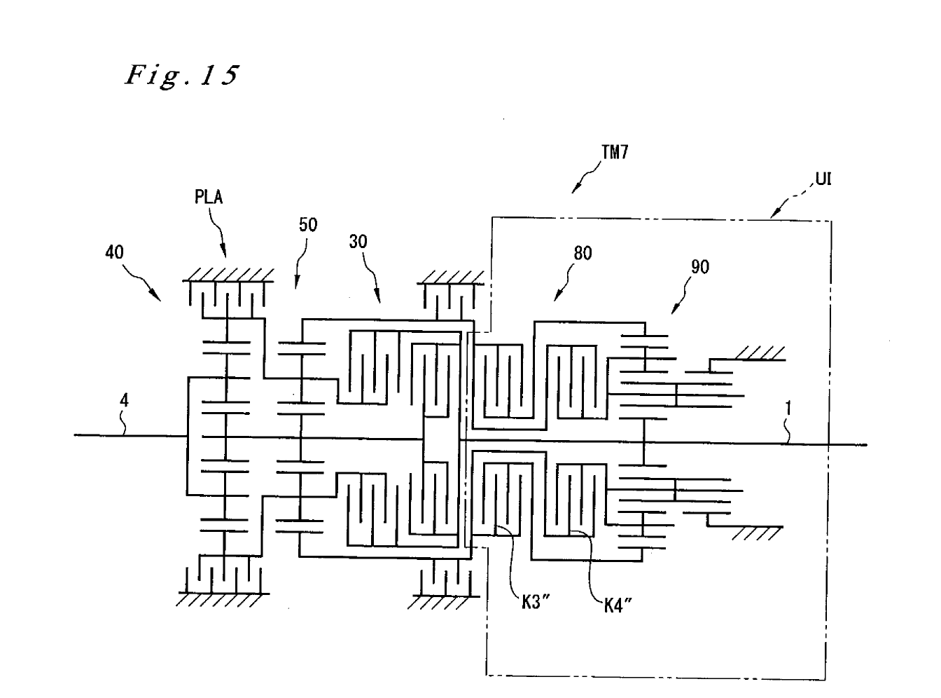

The embodiments of the present invention were explained above. However, the scope of the present invention is not limited to the embodiments described above, and embodiments as shown in FIG. 14 or 15 may be adopted.

The upstream transmission mechanism, in other words the input side transmission unit UI of the automatic transmission TM6 shown in FIG. 14 has a planet gear type transmission mechanism. The compound planet gear train PLA that includes the first planet gear train 40, and the second planet gear train 50, and the planet gear engaging elements 30 provided in the downstream side of the automatic transmission TM6 are the same as for the automatic transmission TM1 described above. The input side transmission unit UI includes an input side planet gear train 60, and input side engaging elements 70 provided upstream of the input side planet gear train 60. The input side planet gear train 60 includes a first input side planet gear train 60a on the downstream side, and a second input side planet gear train 60b on the upstream side, provided in a row on the input shaft 1. The input side engaging elements 70 include a third clutch K3′ and a fourth clutch K4′ provided in a row on the input shaft 1. The third clutch K3′ has the same function as the third clutch K3 of the automatic transmission TM1, and the fourth clutch K4′ has the same function as the fourth clutch K4 of the automatic transmission TM1. By engaging or disengaging the third clutch K3′ or the fourth clutch K4′, the rotation of the input shaft 1 can be transformed and transmitted to the second planet gear train 50 in the downstream side via the input side planet gear train 60. Also, by controlling the engagement and disengagement of the third clutch K3′ and the fourth clutch K4 together with other engaging elements, it is possible to set eight forward gear speeds (1^{st} to 8^{th}) and two reverse gear speeds (REV1, REV2) in the automatic transmission TM6.

On the other hand, the upstream transmission mechanism, in other words the input side transmission unit UI, of the automatic transmission TM7 shown in FIG. 15 has a planet type transmission mechanism, similar to that of the automatic transmission TM6 shown in FIG. 14. The compound planet gear train PLA that includes the first planet gear train 40, and the second planet gear train 50, and the planet gear engaging elements 30 provided in the downstream side of the automatic transmission TM7 are the same as for the automatic transmission TM1 described above. The input side transmission unit UI includes input side engaging elements 80 and an input side planet gear train 90. The input side engaging elements 80 include a third clutch K3″ and a fourth clutch K4″ (the fourth clutch K4″ is on the upstream side) provided in a row on the input shaft 1. The third clutch K3″ has the same function as the third clutch K3 of the automatic transmission TM1, and the fourth clutch K4″ has the same function as the fourth clutch K4 of the automatic transmission TM1. By engaging or disengaging the third clutch K3″ or the fourth clutch K4″, the rotation of the input shaft 1 can be transformed and transmitted to the second planet gear train 50 in the downstream side via the input side planet gear train 90. Also, by controlling the engagement and disengagement of the third clutch K3″ and the fourth clutch K4″ together with other engaging elements, it is possible to set eight forward gear speeds (1^{st} to 8^{th}) and two reverse gear speeds (REV1, REV2) in the automatic transmission TM7.

In this way, even if the transmission according to the present invention does not have a parallel shaft type transmission mechanism as the transmission mechanism in the upstream side, but has a planet gear train type transmission mechanism, it is possible to set predetermined gear speeds the same as in the case where a parallel shaft type transmission mechanism is used.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### RELATED APPLICATIONS

This application claims the priority of Japanese Patent Application No. 2006-158088 filed on Jun. 7, 2006, which is incorporated herein by reference.

1. A transmission, comprising:
an upstream side transmission mechanism that transforms the rotation of an upstream side input member that rotates by receiving input rotation into N steps, and transmits the transformed rotation to an upstream side output member; and
a compound planet gear transmission mechanism having two or more planet gear trains, that transforms the rotation of the upstream side output member and outputs the transformed rotation to an output shaft of the transmission,
wherein of first through fourth rotating elements constituting the compound planet gear transmission mechanism,
the first rotating element can be freely engaged with or disengaged from the upstream side input member via first clutch means;
the second rotating element is connected to the output shaft of the transmission;
the third rotating element can be freely engaged with or disengaged from the upstream side input member via second clutch means, and can be held fixed by second brake means; and
the fourth rotating element can be held fixed by first brake means, and is connected to the upstream side output member.

2. The transmission according to claim 1, wherein the upstream side input member and the input shaft of the compound planet gear transmission mechanism are coaxially positioned.

3. The transmission according to claim 1, wherein the compound planet gear transmission mechanism comprises single pinion type first and second planet gear trains having the same gear ratio, the first rotating element comprises a first sun gear forming the first planet gear train and a second sun gear forming the second planet gear train connected together, the second rotating element comprises a first carrier forming the first planet gear train, the third rotating element comprises a second carrier forming the second planet gear train and a first ring gear forming the first planet gear train connected together, and the fourth rotating element comprises a second ring gear forming the second planet gear train.

4. The transmission according to claim 3, wherein the first and second sun gears are connected so as to rotate integrally and can be freely engaged with or disengaged from the upstream side input member via the first clutch means,
the second carrier is connected so as to rotate integrally with the first ring gear, and can be freely engaged with or disengaged from the upstream side input member via the second clutch means, and can be held fixed by the second brake means,
the second ring gear is connected so as to rotate integrally with the upstream side output member, and can be held fixed by the first brake means, and
the first carrier is connected so as to rotate integrally with the transmission output shaft.

5. The transmission according to any one of claims 1 through 4, wherein the third rotation element further comprises a one way brake that prevents rotation in the opposite direction to the rotation of the input shaft, but allows rotation in the same direction.

6. The transmission according to any one of claims 1 through 4, wherein the upstream side transmission mechanism comprises a parallel shaft transmission mechanism.

7. The transmission according to claim 6, wherein the parallel shaft transmission mechanism comprises:
an input shaft that forms the upstream side input member;
a counter shaft disposed parallel to the input shaft;
a plurality of gear trains provided in a row between the input shaft and the counter shaft;
a drive gear installed connected to the counter shaft; and
a driven gear that is connected so as to rotate integrally with the second ring gear about the same axis as the compound planet gear transmission mechanism, and that meshes with the drive gear, to form the upstream side output member,
and a plurality of gear train selection clutches are provided on the input shaft corresponding to the plurality of gear trains respectively, to select the power transmission by the plurality of gear trains.

8. The transmission according to claim 6, wherein the parallel shaft transmission mechanism comprises:
an input shaft that forms the upstream side input member;
a counter shaft disposed parallel to the input shaft;
a plurality of gear trains provided in a row between the input shaft and the counter shaft;
a drive gear installed connected to the counter shaft; and
a driven gear that is connected so as to rotate integrally with the second ring gear about the same axis as the compound planet gear transmission mechanism, and that meshes with the drive gear, to form the upstream side output member,
and a plurality of gear train selection clutches are provided on the counter shaft corresponding to the plurality of gear trains respectively, to select the power transmission by the plurality of gear trains.

9. The transmission according to claim 6, wherein the parallel shaft transmission mechanism comprises:
an input shaft that forms the upstream side input member;
a counter shaft disposed parallel to the input shaft;
a plurality of gear trains provided in a row between the input shaft and the counter shaft;
a drive gear installed connected to the counter shaft; and
a driven gear that is connected so as to rotate integrally with the second ring gear about the same axis as the compound planet gear transmission mechanism, and that meshes with the drive gear, to form the upstream side output member,
and a plurality of gear train selection clutches are provided on the shaft on which the gear with the smaller diameter in each respective gear train is disposed, the plurality of gear train selection clutches being provided corresponding to the plurality of gear trains respectively, to select the power transmission by the plurality of gear trains.

10. The transmission according to any one of claims 1 through 4, wherein the upstream side transmission mechanism is constituted by a planet gear type transmission mechanism.
